(19) United States
(12) Patent Application Publication
(10) Pub. No.: US 2022/0113408 A1
(43) Pub. Date: Apr. 14, 2022

(54) OPTICAL DISTANCE MEASURING DEVICE

(71) Applicant: DENSO CORPORATION, Kariya-city (JP)

(72) Inventors: Teiyuu KIMURA, Kariya-city (JP); Toshiaki NAGAI, Kariya-city (JP); Sakito MIKI, Kariya-city (JP); Akifumi UENO, Kariya-city (JP)

(21) Appl. No.: 17/645,016

(22) Filed: Dec. 17, 2021

Related U.S. Application Data
(63) Continuation of application No. PCT/JP2020/021737, filed on Jun. 2, 2020.

(30) Foreign Application Priority Data
Jun. 19, 2019 (JP) 2019-113847

(51) Int. Cl. G01S 17/08; G01S 7/481; G01S 7/484; G01S 7/4865

(52) U.S. Cl. CPC G01S 17/08; G01S 7/4817; G01S 7/4815; G01S 7/4865; G01S 7/484

(57) ABSTRACT

An optical distance measuring device using light includes a light-emitting part in which a first and second light-emitting elements that have a light-emitting region, in which a length in a first direction is longer than that in a second direction intersecting the first direction, are separated from each other in the second direction; two projection lenses that are respectively provided to correspond to the first and second light-emitting elements, and are separated from each other in the second direction and arranged at positions overlapping each other in the first direction; a scanner that scans a measurement region with emitted beams emitted from the light-emitting part and have passed through the projection lenses; a light receiving part that receives reflected light of the emitted beams emitted from the light-emitting part; and a measurement section measuring a distance to an object according to a time period from light emission to light reception.

### CROSS-REFERENCE TO RELATED APPLICATION

The present application is based on and claims the benefit of priority from earlier Japanese Patent Application No. 2019-113847 filed on Jun. 19, 2019, the description of which is incorporated herein by reference.

### BACKGROUND

### Technical Field

The present disclosure relates to an optical distance measuring device.

### Related Art

As devices for detecting a forward object, optical distance measuring devices that perform detection by using light have been developed.

SUMMARY An aspect of the present disclosure provides an optical distance measuring device using light. The device includes: a light emitting part in which a first light emitting element and a second light emitting element that have a light emitting region, in which a length in a first direction is longer than a length in a second direction intersecting the first direction, are separated from each other in the second direction by a predetermined distance; two projection lenses that are respectively provided to correspond to the first light emitting element and the second light emitting element, and are separated from each other in the second direction and arranged at positions overlapping each other in the first direction; a scanner that scans a measurement region with emitted beams emitted from the light emitting part and have passed through the two projection lenses; a light receiving part that receives reflected light of the emitted beams emitted from the light emitting part; and a measurement section that measures a distance to an object according to a time period from light emission by the light emitting part to light reception by the light receiving part.

### BRIEF DESCRIPTION OF THE DRAWINGS

In the accompanying drawings:

FIG. 1 is an explanatory diagram illustrating an optical distance measuring device;

FIG. 2 is a block diagram of the optical distance measuring device;

FIG. 3 is an explanatory diagram illustrating an emitted beam and movement of reflected light of the emitted beam in the optical distance measuring device;

FIG. 4 is an explanatory diagram illustrating a configuration of a measurement section;

FIG. 5 is an example of a histogram;

FIG. 6 is diagram illustrating an emitted beam and an angular width of the emitted beam;

FIG. 7 is diagram illustrating an example for enlarging the angular width of the emitted beam;

FIG. 8 is diagram of light emitting elements and projection lenses seen in an x direction;

FIG. 9A is an explanatory diagram illustrating a second embodiment;

FIG. 9B is an explanatory diagram illustrating a modification of the second embodiment;

FIG. 9C is an explanatory diagram illustrating a modification of the second embodiment;

FIG. 10 is an explanatory diagram illustrating an irradiated area and unirradiated area according to the second embodiment;

FIG. 11 is an explanatory diagram illustrating a third embodiment;

FIG. 12 is an explanatory diagram illustrating a fourth embodiment;

FIG. 13 is an explanatory diagram illustrating a fifth embodiment;

FIG. 14 is an explanatory diagram illustrating a sixth embodiment;

FIG. 15 is an explanatory diagram illustrating a seventh embodiment;

FIG. 16 is a perspective view of a light emitting part;

FIG. 17 is diagram of the light emitting part including the projection lenses seen in a z direction;

FIG. 18A illustrates a configuration including light refraction members as light guiding paths narrowing a distance between two emitted beams;

FIG. 18B illustrates a configuration including reflecting mirrors as light guiding paths narrowing a distance between two emitted beams;

FIG. 19 is diagram of projection lenses seen in the x direction;

FIG. 20 is an explanatory diagram illustrating a light emitting control circuit of the light emitting element;

FIG. 21 illustrates an example of light receiving intensity of reflected light in a case in which a displacement between two emitted beams is large;

FIG. 22 illustrates an example of light receiving intensity of reflected light in a case in which a displacement between two emitted beams is small;

FIG. 23 illustrates an example of light receiving intensity of reflected light in a case in which two emitted beams are individually emitted;

FIG. 24 is an explanatory diagram illustrating a configuration of a timing adjustment section;

FIG. 25 illustrates an example in which a slew rate of a drive pulse is adjusted to adjust an emission timing of the light emitting element;

FIG. 26 illustrates an example in which a peak voltage of a drive pulse is adjusted to adjust an emission timing of the light emitting element;

FIG. 27 is an explanatory diagram illustrating an example of a configuration in which the timing adjustment section has a delay circuit;

FIG. 28 is a diagram illustrating an example of a configuration of the delay circuit;

FIG. 29 illustrates an example of a case in which light receiving intensity of reflected light of two emitted beams exceeds a maximum range; and

FIG. 30 illustrates an example of light receiving intensity of reflected light in a case in which light emitting timings of two emitted beams are displaced from each other.

### DETAILED DESCRIPTION OF THE PREFERRED EMBODIMENTS

As devices for detecting a forward object, optical distance measuring devices that perform detection by using light have been developed (for example, JP 2015-78953 A). The device performs scanning in the horizontal direction (short side direction of a beam) with the beam having a belt-like shape elongated in the vertical direction. A light-irradiated range in the vertical direction is determined by a length of the beam in a long side direction and a magnification of a projection lens.

Recently, it is desired to enlarge a light-irradiated range, especially, a light-irradiated range in the vertical direction to enlarge a detection area of an object. Hence, a simple configuration for enlarging the light-irradiated range in the vertical direction is desired.

### First Embodiment

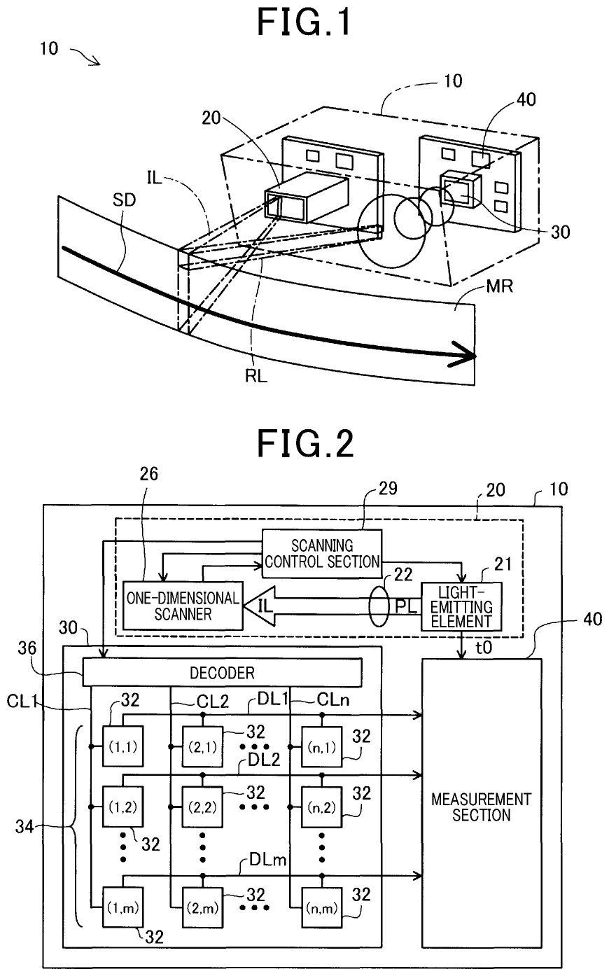

An optical distance measuring device 10 is installed in, for example, a vehicle and is used for measuring a distance to an object. As shown in FIG. 1, the optical distance measuring device 10 includes a light emitting part 20, a light receiving part 30, and a measurement section 40. The light emitting part 20 emits an emitted beam IL to a measurement region MR. In the present embodiment, the light emitting part 20 performs scanning with the emitted beam IL in a scanning direction SD. The emitted beam IL has a rectangular shape whose longitudinal direction is orthogonal to the scanning direction SD. The light receiving part 30 receives reflected light RL from a region including the measurement region MR depending on emission of the emitted beam IL, and outputs a signal according to a light receiving state of the reflected light RL. The measurement section 40 uses the signal output from the light receiving part 30 to measure a distance to an object present in the measurement region MR. The scanning direction is not limited, and two-dimensional scanning may be performed.

FIG. 2 is a block diagram of the optical distance measuring device 10. The light emitting part 20 includes a light emitting element 21, a projection lens 22, a scanning control section 29, and a one-dimensional scanner 26, which is a scanning device. The light emitting element 21 is configured by, for example, a semiconductor laser diode and emits a pulse laser beam PL to the one-dimensional scanner 26. The projection lens 22 allows the pulse laser beam PL to pass therethrough to generate the emitted beam IL having an elongated rectangular shape.

The one-dimensional scanner 26 reflects the emitted beam IL to one-dimensionally scan the measurement region MR in the SD direction. The one-dimensional scanner 26 has a mirror and a forced-resonance type MEMS. The one-dimensional scanner 26 drives the forced-resonance type MEMS to gradually change the angle of the mirror to change the direction of the emitted beam IL, thereby performing one-dimensional scanning in the SD direction. Instead of the forced-resonance type MEMS, a reciprocating or rotating mirror may be used.

The scanning control section 29 detects a scanning angle of the one-dimensional scanner 26, and controls emissions of the pulse laser beam PL by the light emitting element 21 and scanning with the emitted beam IL using the one-dimensional scanner 26, based on the result of the detection.

The light receiving part 30 includes a light receiving element array 34 and a decoder 36. The light receiving element array 34 is configured by arranging a plurality of light receiving elements 32 in a two-dimensional array of n columns*m rows (n, m are natural numbers of 2 or more). The light receiving element 32 is configured by a single-photon avalanche photodiode (SPAD). The light receiving element array 34 is an SPAD array. When light such as reflected light is received by a light receiving surface of the light receiving element 32, the light receiving element 32 outputs a detection signal. The configuration of the light receiving element 32 will be described later.

The decoder 36 is a circuit for selecting the light receiving element 32. The decoder 36 includes selection control lines CL1 to CLn provided for respective rows of the matrix formed by the plurality of light receiving elements 32. The selection control lines CL1 to CLn are respectively provided for columns each of which includes m light receiving elements 32 arranged in the corresponding column. The decoder 36 applies a selection control voltage sequentially to the selection control lines CL1 to CLn to sequentially select the light receiving elements 32 per column. Data of the light receiving elements 32 selected per column are output to data lined DL1 to DLm provided for the respective rows. The direction of the row corresponds to a second direction described later. A measurement section 40 described later performs signal processing for each of the rows provided in the second direction.

The measurement section 40 measures a distance to an object that has reflected the emitted beam IL, based on the difference between time t0 at which the light emitting element 21 emits the emitted beam IL and the time at which the light receiving part 30 detects reflected light RL. The measurement section 40 is connected to the data lined DL1 to DLm provided for the respective rows. The configuration and data processing of the measurement section 40 will be described later in detail.

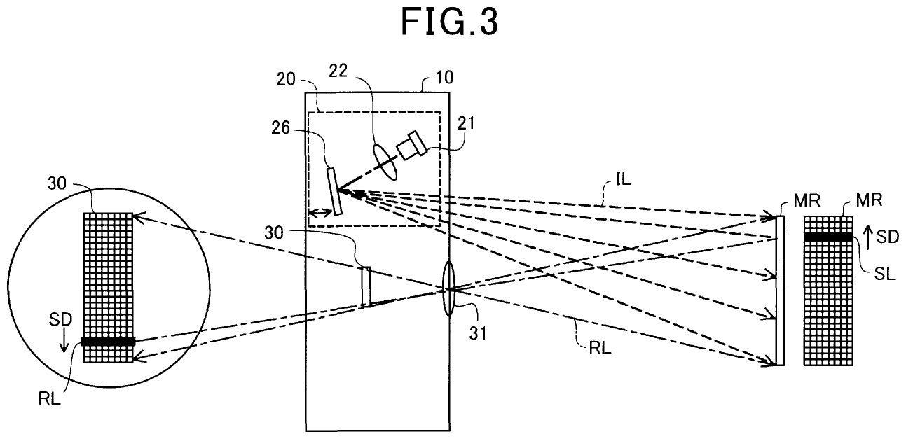

With reference to FIG. 3, a state will be described in which a pulse laser beam is emitted from the light emitting element 21 and reaches the light receiving part 30. The pulse laser beam emitted from the light emitting element 21 having an elongated rectangular shape is enlarged by the projection lens 22 to become the emitted beam IL. The emitted beam IL having a rectangular shape is reflected by the one-dimensional scanner 26 and travels to an object (not shown). The reflected light RL, which has reflected diffusely by a surface of the object, is condensed by a light receiving lens 31 and enters the light receiving part 30.

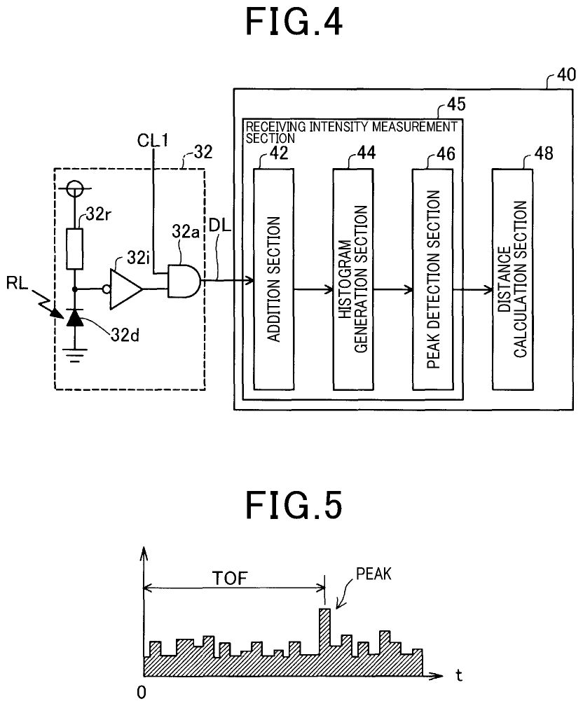

As shown in FIG. 4, the light receiving element 32 is configured by a well-known circuit including an avalanche photodiode 32d, a quenching resistor 32r, an inverter circuit 32i, and an AND circuit 32a. More specifically, in the light receiving element 32, the quenching resistor 32r and the avalanche photodiode 32d are connected in series between a power supply and a grounding line. The connecting point between the quenching resistor 32r and the avalanche photodiode 32d is connected with an input side of the inverter circuit 32i. The quenching resistor 32r is connected a power supply side. The avalanche photodiode 32d is connected to a grounding line side so as to be reverse-biased. The light receiving element 32 operates in a Geiger mode. On receiving reflected light (one or more photons) reflected from an object, the light receiving element 32 outputs a pulse signal indicating the reception of the reflected light at a constant probability. The AND circuit 32a has received the pulse signal indicating the reception of the reflected light and a signal for selecting a selection control lines CL1. That is, pulse signals obtained from the light receiving elements 32 arranged in a column connected to the selection control line selected by a decoder 36, for example, the selection control lines CL1 are output to, for example, data lines DL1 to DLm.

The measurement section 40 includes a light receiving intensity measurement section 45 and a distance calculation section 48 for each of the data lines DL1 to DLm. The light receiving intensity measurement section 45 includes an addition section 42, a histogram generation section 44, and a peak detection section 46.

The addition section 42 adds the numbers of the pulse signals, which are output from the plurality of light receiving elements 32 included in the light receiving part 30 to the data line DL1 approximately at the same time, to obtain an additional value. The addition section 42 outputs the obtained additional value to the histogram generation section 44.

The histogram generation section 44 generates a histogram based on the additional value output from the addition section 42. FIG. 5 illustrates an example of the histogram. The class (horizontal axis) of the histogram indicates a travel duration of light from the time at which the light is emitted from the light emitting element 21 to the time at which the reflected light is received. The travel duration is also referred to as TOF (Time of Flight). The frequency (vertical line) of the histogram is an additional value calculated by the addition section 42 and indicates intensity of the reflected light RL reflected from an object. The histogram generation section 44 generates a histogram by recording the additional values output from the addition section 42 at predetermined time intervals in accordance with the recording timing synchronized with a period of the emitted beam emitted from the light emitting element 21. If an object is present in an area to which the beam is emitted by the light emitting element 21, the frequency of the class corresponding to the time at which the reflected light RL is received from the object becomes high. That is, if a class having a high frequency is present in the histogram, the distance to the object can be calculated based on the time corresponding to the class. When one histogram is generated, a beam may be emitted multiple times to sum frequencies. Accordingly, the S/N ratio can be improved.

The peak detection section 46 detects a peak from the histogram. In the present embodiment, the peak is a frequency exceeding a predetermined threshold value and refers to a maximal frequency. The distance calculation section 48 calculates a distance to the object from the time corresponding to the peak.

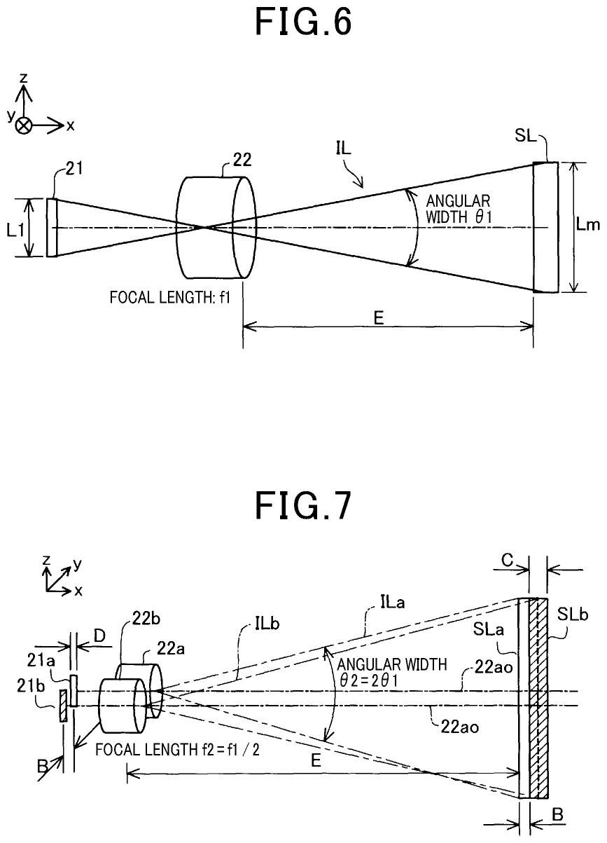

As illustrated in FIG. 6, the pulse laser beam emitted from the light emitting element 21 becomes the emitted beam IL by the projection lens 22 and is enlarged as irradiation light SL at the position distanced from the projection lens 22 by a distance E. When the length of the light emitting element 21 in a first direction is L1, the focal length of the projection lens 22 is f1, the length of the irradiation light SL in the first direction is L, and the angular width of the emitted beam IL is θ1, the following expressions are obtained.

Lm=L1*E/f1 (1)

Lm=2*E*tan (θ1/2) (2)

The first direction is a longitudinal direction of the light emitting element 21 and is the z direction in FIG. 6. The accompanying diagrams including FIG. 6 are schematic diagrams for facilitating visualization. In the diagrams, sizes and angles are not to scale. The one-dimensional scanner 26 is not shown.

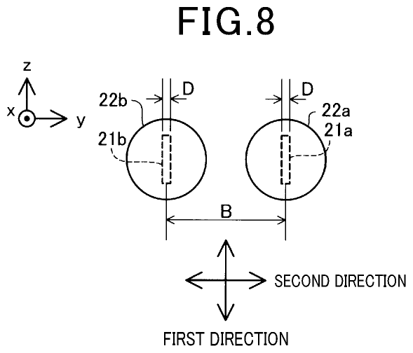

FIG. 7 and FIG. 8 illustrates a method for doubling the angular width of the emitted beam according to the present embodiment. In the present embodiment, two light emitting elements 21a, 21b and two projection lenses 22a, 22b are provided. Each of the two light emitting elements 21a, 21b has a length of L1 in the first direction (z direction) and a length of D in the second direction (y direction) intersecting the first direction, where L1>D. The two light emitting elements 21a, 21b are separated from each other in the second direction with a distance B. The first projection lens 22a is provided to correspond to the first light emitting element 21a. The second projection lens 22b is provided to correspond to the second light emitting element 21b. The first light emitting element 21a is located on an optical axis 22ao of the projection lens 22a. The second light emitting element 21b is located on an optical axis 22bo of the projection lens 22b. The optical axes 22ao, 22bo are parallel to each other in the x direction. The two projection lenses 22a, 22b are separated from each other in the second direction and arranged at positions overlapping each other in the first direction. The wording “separated from each other in the second direction” means that when viewed in the direction intersecting the second direction, for example, the x direction, the two projection lenses 22a, 22b are seen such that the two projection lenses 22a, 22b do not overlap each other. The wording “positions overlapping each other in the first direction” means that when viewed in the direction intersecting the first direction, for example, the direction along the second direction, the two projection lenses 22a, 22b are seen such that at least parts of the two projection lenses 22a, 22b overlap each other. Each of the focal lengths f2 of the two projection lenses 22a, 22b is a half of the focal length f1 of the projection lens 22 shown in FIG. 6.

In the present embodiment, widths of an emitted beam ILa, which is emitted from the light emitting element 21a, and an emitted beam ILb, which is emitted from the light emitting element 21b, of irradiated areas SLa, SLb in the second direction are enlarged to C at a target of the emission. The width C is expressed by the following expression (3).

C=D*E/F2 (3)

The first projection lens 22a is provided to correspond to the first light emitting element 21a. The second projection lens 22b is provided to correspond to the second light emitting element 21b. The first emitted beam ILa does not pass through the second projection lens 22b. The second emitted beam ILb does not pass through the first projection lens 22a. Hence, the two emitted beams ILa, ILb are emitted while maintaining a state in which the emitted beams ILa, ILb are shifted in the second direction by B. At the target of the emission, the amount of the shift is not enlarged and remains B. The irradiated areas SLa, SLb overlap each other by a range of C-B within the width C of the irradiated areas SLa, SLb. Typically, since E>>f2, C>>B is established. Hence, the two emitted beams ILa, ILb substantially overlap each other and can be assumed as substantially one emitted beam. For example, when the length D of the first and second light emitting elements 21a, 21b in the second direction is 10 μm, the focal length f1 is 5 mm, and the distance E to the target of the emission is 100 m, C is 0.2 m (200 mm). When the distance between the two light emitting elements 21a and 21b is 6 mm, C+B is 206 mm, and C>>B. Hence, the two emitted beams ILa, ILb substantially overlap each other and can be assumed as a substantially one emitted beam.

The intensity of light per unit area at a portion at which the two emitted beams ILa, ILb overlap each other is the same as the intensity of light per unit area of one emitted beam IL in FIG. 6. This is because, although the amount of light at the portion at which the two emitted beams ILa, ILb overlap each other is doubled at the target of the emission, the length in the first direction is doubled, whereby the intensity of light per unit area is the same.

As described above, according to the first embodiment, there are provided the light emitting element 21 in which the first light emitting element 21a and the second light emitting element 21b that have a light emitting region in which the length L1 in the first direction is longer than the length D in the second direction intersecting the first direction are separated from each other in the second direction by the predetermined distance B, and the two projection lenses 22a, 22b that are provided to respectively correspond to the first light emitting element 21a and the second light emitting element 21b, separated from each other in the second direction, and arranged at positions overlapping each other in the first direction. Hence, at the target of the emission, the angular width of the emitted beams ILa, ILb can be approximately doubled compared with the configuration illustrated in FIG. 6 without lowering the intensity of light per unit area.

### Second Embodiment

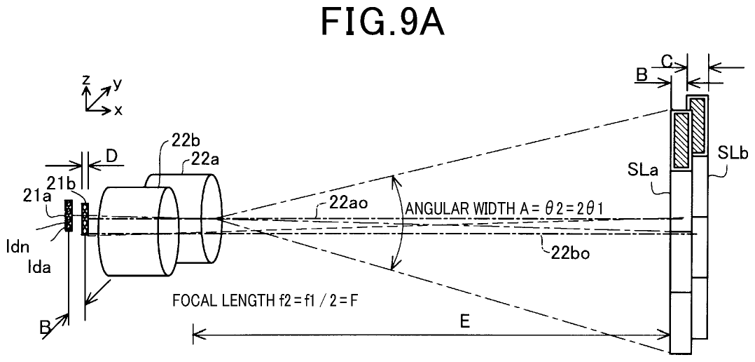

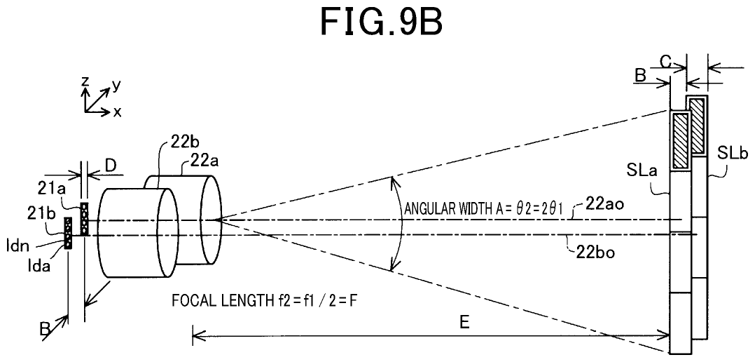

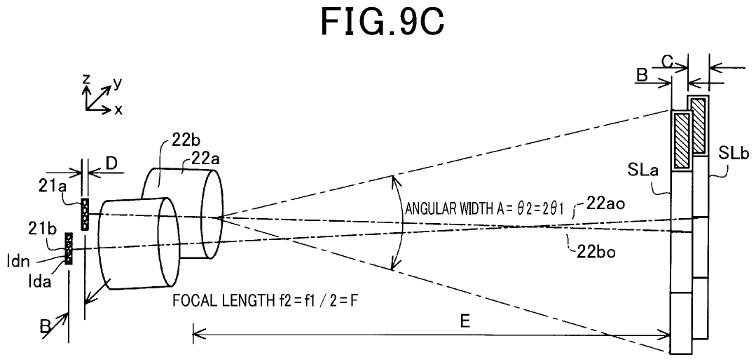

In an example illustrated in FIG. 9A, the first light emitting element 21a is slightly displaced from the second light emitting element 21b in the first direction (z direction). That is, the optical axes 22ao, 22bo of two projection lenses 22a, 22b are parallel to each other. The first light emitting element 21a is shifted from the optical axis 22ao of the corresponding projection lens 22a in the direction (−z direction) opposite to the first direction. The second light emitting element 21b is shifted from the optical axis 22bo of the corresponding projection lens 22b in the first direction. In the present embodiment, the first light emitting element 21a has four light emitting regions Ida arranged in the first direction. Three non-light emitting regions Idn, which do not emit light, are provided between the adjacent light emitting regions Ida. That is, the four light emitting regions Ida are arranged in the first direction in a state in which the non-light emitting regions Idn are provided between the adjacent light emitting regions Ida. The non-light emitting regions Idn are provided to increase output of the light emitting regions Ida of the light emitting elements 21a, 21b. Similarly, the second light emitting element 21b includes light emitting regions Idb and non-light emitting regions Idn. The size of the non-light emitting region Idn in the first direction is smaller than the size of the light emitting region Ida in the first direction. The first light emitting element and the second light emitting element are shifted from each other in the first direction so that the light emitting region Ida of the first light emitting element is located at a position at which the light emitting region Ida overlaps with the non-light emitting region Idn of the second light emitting element in the first direction.

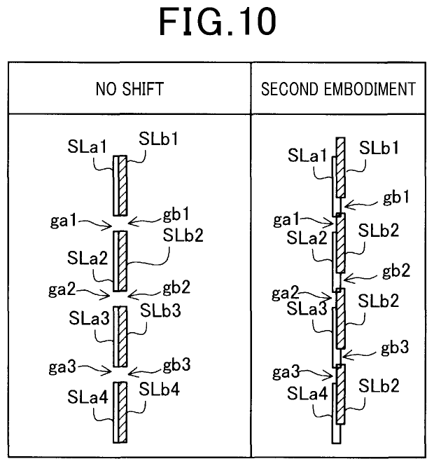

As shown in FIG. 10, at the target of the emission, the first emitted beam ILa forms four irradiated areas SLa1, SLa2, SLa3, SLa4 in the first direction. Between the irradiated areas SLa1, SLa2, SLa3, SLa4, unirradiated areas ga1, ga2, ga3 due to the non-light emitting region Idn are generated. Similarly, the second emitted beam ILb forms four irradiated areas SLb1, SLb2, SLb3, SLb4. Between the irradiated areas SLb1, SLb2, SLb3, SLb4, unirradiated areas gb1, gb2, gb3 due to the non-light emitting region Idn are generated. The four irradiated areas SLa1, SLa2, SLa3, SLa4 and the four irradiated areas SLb1, SLb2, SLb3, SLb4 overlap each other in the second direction by a range of C-B within the width C after the enlargement. The four irradiated areas SLa1, SLa2, SLa3, SLa4 and the four irradiated areas SLb1, SLb2, SLb3, SLb4 are also shifted in the first direction. Specifically, the irradiated area SLb2 of the second emitted beam ILb is located at the unirradiated area gal between the irradiated areas SLa1 and SLa2. Similarly, the irradiated area SLb3 is located at the unirradiated area ga2, and the irradiated area SLb4 is located at the unirradiated area ga3. In contrast, the irradiated area SLa1 of the first emitted beam ILa is located at the unirradiated area gb1 between the irradiated areas SLb1 and SLb2, the irradiated area SLa2 is located at the unirradiated area gb2, and the irradiated area SLa3 is located at the unirradiated area gb3. As a result, at the target of the emission, since at least one of the first emitted beam ILa and the second emitted beam ILb is emitted, there is no area to which neither the first emitted beam ILa nor the second emitted beam ILb is emitted. Accordingly, areas to which the emitted beams ILa, Ilb are not emitted and which cannot be detected can be eliminated.

In the second embodiment, each of the first light emitting element 21a and the second light emitting element 21b has the four light emitting regions Ida arranged in the first direction. However, each of the first light emitting element 21a and the second light emitting element 21b may have a configuration including n (n is 2 or more) light emitting regions Ida arranged in the first direction. The numbers of the light emitting regions Ida of the first light emitting element 21a and the second light emitting element 21b may be the same or differ from each other by 1.

The positions of the light receiving elements 32 corresponding to the unirradiated areas ga1 to ga3 and gb1 to gb3 are previously known. Hence, even when light receiving intensity of the reflected light RL at the receiving elements 32 corresponding to the unirradiated areas ga1 to ga3 and gb1 to gb3 is low, performing normalization such that values of a histogram of detection signals from the corresponding receiving elements 32 are doubled can respond to the lowered light receiving intensity.

An example illustrated in FIG. 9B is a modification of the example illustrated in FIG. 9A. The optical axes 22ao, 22bo of the two projection lenses 22a, 22b are parallel to each other. The first light emitting element 21a is located on the optical axis 22ao of the corresponding projection lens 22a. The second light emitting element 21b is located on the optical axis 22bo of the corresponding projection lens 22b. The two optical axes 22ao, 22bo are shifted from each other in the first direction. According to such a configuration, effects similar to those of the second embodiment illustrated in FIG. 9A are provided.

In an example illustrated in FIG. 9C, the first light emitting element 21a is located on the optical axis 22ao of the corresponding projection lens 22a, the second light emitting element 21b is located on the optical axis 22bo of the corresponding projection lens 22b, and the two optical axes 22ao, 22bo are respectively inclined in the first direction and in the direction opposite to the first direction. According to such a configuration, effects similar to those of the second embodiment illustrated in FIG. 9A are provided.

### Third Embodiment

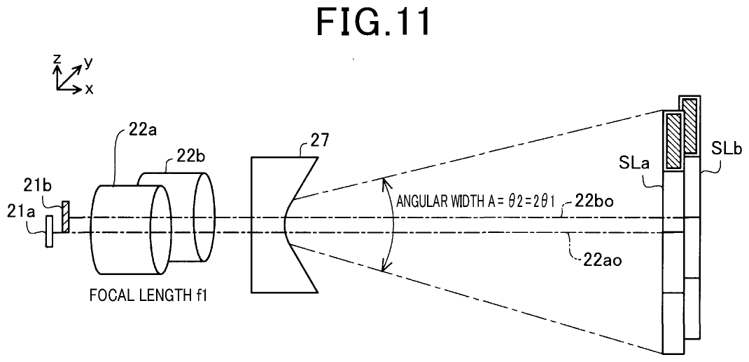

In the third embodiment illustrated in FIG. 11, a cylindrical lens 27 is provided at the subsequent stage of the two projection lenses 22a, 22b. The cylindrical lens 27 has a function of enlarging the angular width of the emitted beams ILa, ILb in the first direction by a factor of two. It is noted that the cylindrical lens 27 does not enlarge the angular width of the emitted beams ILa, ILb in the second direction.

According to the third embodiment, the cylindrical lens 27 is used to enlarge the angular width of the first emitted beam ILa and the second projection lens 22b by a factor of two with respect to that in a case in which the cylindrical lens 27 is not used. Hence, even when projection lens having the same focal length as the focal length f1 of the projection lens 22 shown in FIG. 6 is used as the two projection lenses 22a, 22b, the angular width can be doubled. The intensity of light per unit area at a portion at which the two emitted beams ILa, ILb overlap each other may be the same as the intensity of light per unit area of one emitted beam IL in FIG. 6. Since the cylindrical lens 27 does not enlarge the angular width in the second direction, the angular width in the first direction can be enlarged without lowering resolution for detection in the second direction because the width of the emitted beams ILa, ILb in the second direction is not enlarged.

### Fourth Embodiment

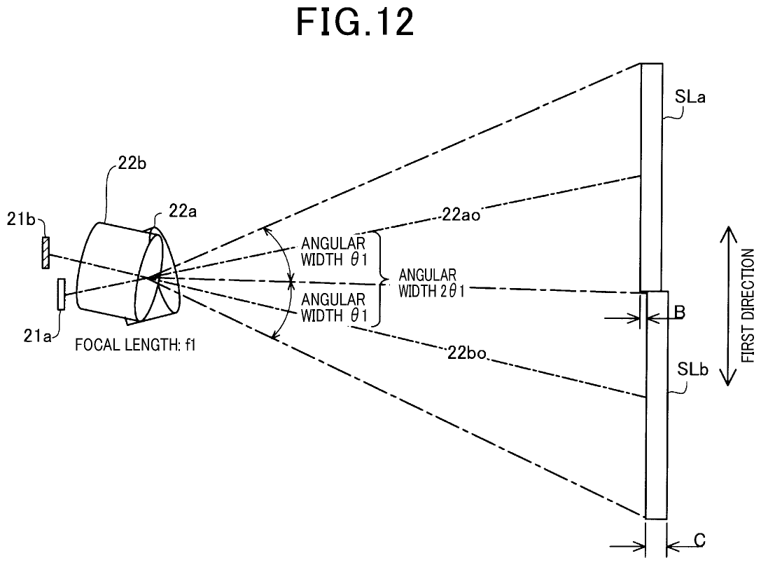

In the fourth embodiment illustrated in FIG. 12, the first light emitting element 21a and the second light emitting element 21b are arranged so that a first area SLa subjected to emission by the first light emitting element 21a and a second area SLb subjected to emission by the second light emitting element 21b contact each other in the first direction. That is, the first light emitting element 21a is located on the optical axis 22ao of the corresponding projection lens 22a. The second light emitting element 21b is located on the optical axis 22bo of the corresponding projection lens 22b. The two optical axes 22ao, 22bo are respectively inclined in the first direction and in the direction opposite to the first direction. As a result, the first emitted beam ILa is emitted to an area corresponding to an angular width θ1 on the upper side in FIG. 12, the second emitted beam ILb is emitted to an area corresponding to an angular width θ1 on the lower side in FIG. 12, and both of the first emitted beam ILa and the second emitted beam ILb are emitted to an area corresponding to an angular width 2θ1. The intensity of light at the first area SLa and the second area SLb is the same as that in FIG. 6.

As described above, according to the fourth embodiment, the angular width of the emitted beams ILa, ILb can be doubled, and the intensity of light per unit area at the target of the emission can be the same as the intensity of light per unit area of one emitted beam IL illustrated in FIG. 6.

According to the fourth embodiment, the first area SLa and the second area SLb are merely shifted in the second direction by B, and contact each other in a length of C−B. Since C>>B, the first area SLa and the second area SLb can be assumed as a substantially one area. Since C>>B, the two emitted beams can be assumed as substantially one beam at the target of the emission. According to the fourth embodiment, since the centers of the two projection lenses 22a, 22b are located at the same position with respect to the first direction, there are no places that cannot be detected.

### Fifth Embodiment

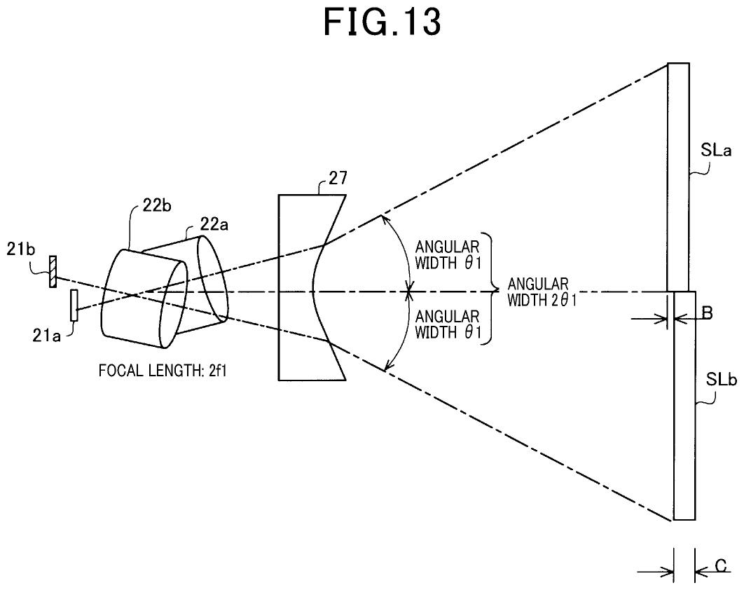

In the fifth embodiment illustrated in FIG. 13, the cylindrical lens 27 is provided at the subsequent stage of the two projection lenses 22a, 22b. The focal length of the projection lenses 22a, 22b is 2f1, which is twice that in the example illustrated in FIG. 6.

According to the fifth embodiment, as in the fourth embodiment, the angular width of the emitted beams ILa, ILb is doubled, and the intensity of light per unit area at the target of the emission can be the same as the intensity of light per unit area of one emitted beam IL illustrated in FIG. 6. In addition, since the cylindrical lens 27 does not enlarge the angular width in the second direction, as in the third embodiment, the angular width in the first direction can be enlarged without lowering the accuracy in the second direction.

According to the fifth embodiment, as in the fourth embodiment, the first area SLa and the second area SLb are merely shifted in the second direction by B, and contact each other in a length of C−B. Since C>>B, the first area SLa and the second area SLb can be assumed as substantially one area. In addition, even when the first light emitting element 21a and the second light emitting element 21b include non-light emitting regions, since the four irradiated areas SLa1, SLa2, SLa3, SLa4 are enlarged in the first direction, the unirradiated areas ga1, ga2, ga3 due to the non-light emitting region can be eliminated.

### Sixth Embodiment

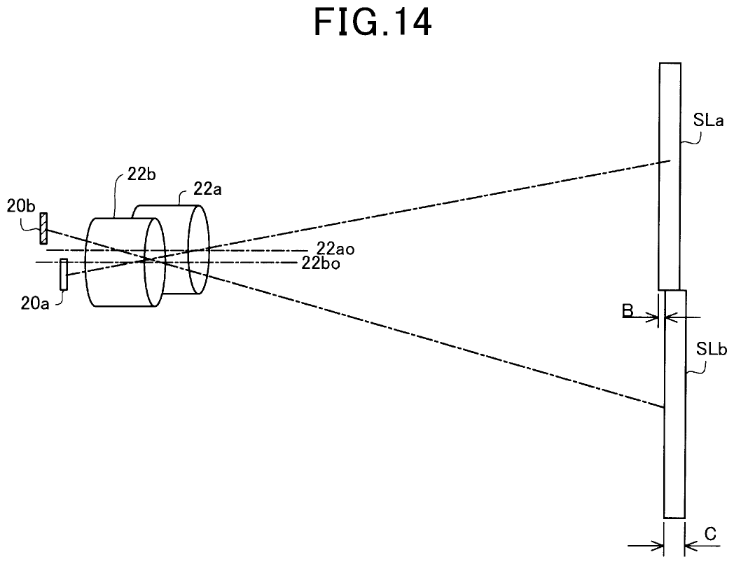

The sixth embodiment illustrated in FIG. 14 is similar to the fourth embodiment illustrated in FIG. 12, but differs from the fourth embodiment as below. In the fourth embodiment, the central axis 22ao of the first projection lens 22a and the central axis 22bo of the second projection lens 22b are not parallel to each other, but separated from each other in the first direction at the target of the emission. In contrast, in the sixth embodiment, the central axis 22ao of the first projection lens 22a and the central axis 22bo of the second projection lens 22b are parallel. The first light emitting element 21a is shifted from the optical axis 22ao of the corresponding projection lens 22a in the direction (−z direction) opposite to the first direction. The second light emitting element 21b is shifted from the optical axis 22bo of the corresponding projection lens 22b in the first direction (z direction). The first emitted beam ILa is not parallel to the central axis 22ao of the first projection lens 22a. The second light emitting element 21b is not parallel to the central axis 22bo of the second projection lens 22b.

According to the sixth embodiment, as in the fourth embodiment, the angular width of the emitted beams ILa, ILb can be doubled, and the intensity of light per unit area at the target of the emission can be the same as the intensity of light per unit area of one emitted beam IL illustrated in FIG. 6. Since C>>B, the two emitted beams can be assumed as substantially one beam at the target of the emission.

### Seventh Embodiment

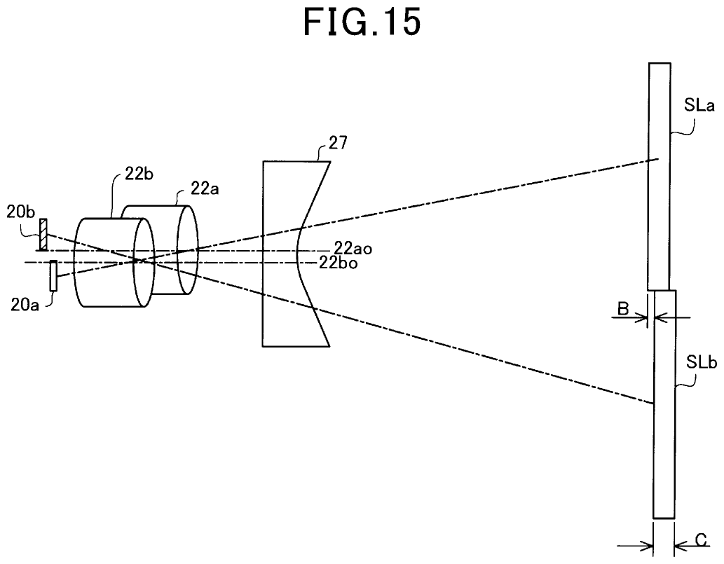

The seventh embodiment illustrated in FIG. 15 is similar to the fifth embodiment illustrated in FIG. 13. However, as in the sixth embodiment with respect to the fourth embodiment, the central axis 22ao of the first projection lens 22a and the central axis 22bo of the second projection lens 22b are parallel to each other. The positions of the light emitting elements 21a, 21b in the first direction are displaced from each other. The first emitted beam ILa is not parallel to the central axis 22ao of the first projection lens 22a. The second emitted beam ILb is not parallel to the central axis 22bo of the second projection lens 22b.

According to the seventh embodiment, as in the fifth embodiment, the angular width of the emitted beams ILa, ILb can be doubled, and the intensity of light per unit area at the target of the emission can be the same as the intensity of light per unit area of one emitted beam IL illustrated in FIG. 6. Since C>>B, the two emitted beams can be assumed as substantially one beam at the target of the emission.

### Embodiments of Components

Hereinafter, configurations and control of the first light emitting element 21a and the second light emitting element 21b will be described in series. The configurations and control can be applied to the above first to seventh embodiments.

### Configurations of First Light Emitting Element 21a and Second Light Emitting Element 21b

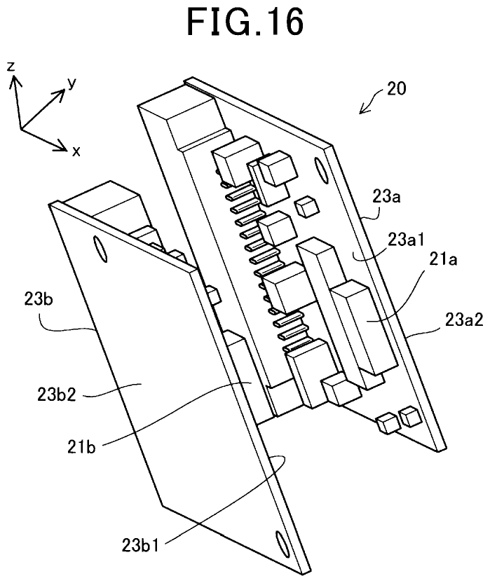

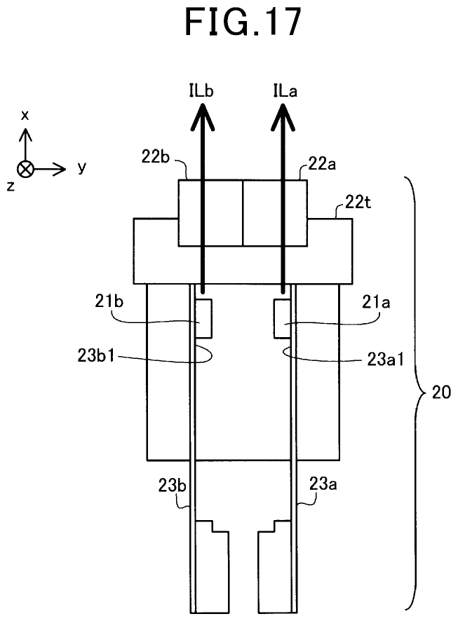

With reference to FIG. 16 and FIG. 17, the configurations of the first light emitting element 21a and second light emitting element 21b will be described. FIG. 16 is a perspective view. FIG. 17 is diagram of the light emitting part 20 including the projection lens 22a, 22b seen in the z direction. As described above, the configurations illustrated in FIG. 16 and FIG. 17 can be applied to the first to seventh embodiments.

The first light emitting element 21a is disposed on one surface 23a1 of a first substrate 23a. The second light emitting element 21b is disposed on one surface 23b1 of a second substrate 23b. The surface 23a1 and the surface 23b1 face to each other. The emitted beams ILa, ILb emitted from the first light emitting element 21a and the second light emitting element 21b respectively pass through the projection lenses 22a, 22b and are emitted in the x direction. Outer edges of the projection lenses 22a, 22b are provided with a lens barrel 22t. The lens barrel 22t surrounds the first light emitting element 21a on the first substrate 23a and the second light emitting element 21b on the second substrate 23b.

According to the above configuration, since the surface 23a1 on which the first light emitting element 21a is disposed and the surface 23b1 on which the second light emitting element 21b is disposed face to each, the distance B between the first light emitting element 21a and the second light emitting element 21b can be small. As a result, the ratio of overlap between the emitted beams ILa, ILb at the target of the emission can be high.

According to the above configuration, since the first light emitting element 21a and the second light emitting element 21b are disposed on the surfaces 23a1, 23b1 facing to each other, heat release structures such as a heat sink can be fitted to the rear surfaces of the surfaces 23a1, 23b1, that is, surfaces 23a2, 23b2. As a result, hear generated in the first light emitting element 21a and the second light emitting element 21b can be easily released.

### Configuration Including Light Guiding Paths

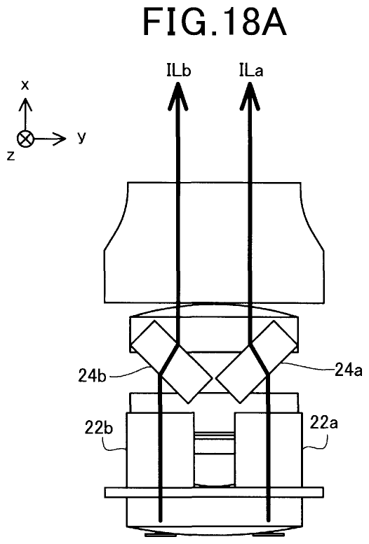

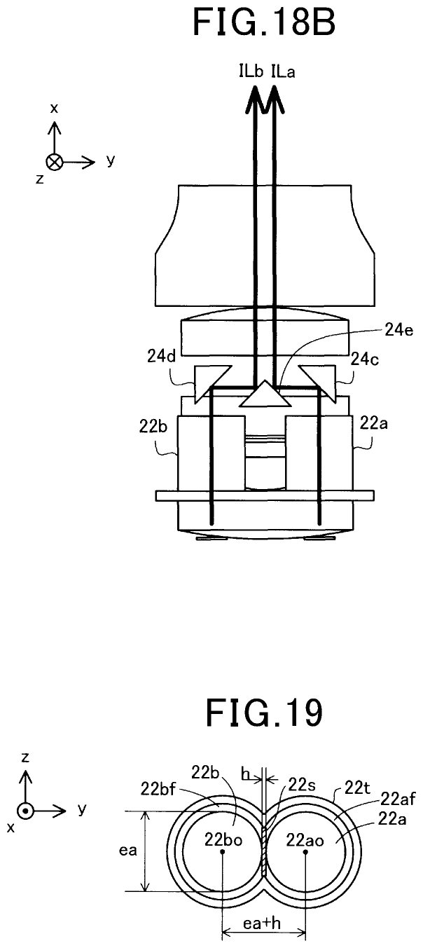

The configurations illustrated in FIG. 18A and FIG. 18B include light guiding paths narrowing the distance between the emitted beams ILa, ILb. The configurations can be also applied to the first to seventh embodiments as described above. The configuration illustrated in FIG. 18A includes light refraction members 24a, 24b at the subsequent stage of the projection lenses 22a, 22b. The light refraction members 24a, 24b function as light guiding paths and refract the emitted beams ILa, ILb to narrow the distance between the emitted beams ILa, ILb. As a result, the ratio of overlap between the emitted beams ILa, ILb at the target of the emission can be high.

The configuration illustrated in FIG. 18B includes light reflection members 24c, 24d, 24e at the subsequent stage of the projection lenses 22a, 22b. The light reflection members 24c, 24d, 24e also function as light guiding paths and reflect the emitted beams ILa, ILb to narrow the distance between the emitted beams ILa, ILb. As a result, the ratio of overlap between the emitted beams ILa, ILb at the target of the emission can be high.

FIG. 19 is diagram of the projection lenses 22a, 22b seen in the x direction according to the first to seventh embodiments. Outer edges of the two projection lenses 22a, 22b are respectively provided with flat parts 22af, 22bf. Outer edges of the flat parts 22af, 22bf are provided with the lens barrel 22t. A light shielding wall 22s is provided between the two projection lenses 22a, 22b. The light shielding wall 22s contact the lens barrel 22t in the z direction. The two projection lenses 22a, 22b are surrounded by the lens barrel 22t or the light shielding wall 22s in the direction intersecting the direction (x direction) of the emitted beams ILa, ILb. Hence, the emitted beams ILa, ILb are not mixed.

When a lens effective diameter of the projection lenses 22a, 22b is ea, and the thickness of the light shielding wall 22s is h, the distance between the central axis 22ao of the first projection lens 22a and the central axis 22bo of the second projection lens 22b is ea+h. The lens effective diameter refers to an area where the angular width of the emitted beams ILa, ILb can be enlarged. Since the second direction (y direction) does not concern enlargement of the angular width of the emitted beams ILa, ILb in the first direction (z direction) due to the projection lenses 22a, 22b, the distance between the central axis 22ao of the first projection lens 22a and the central axis 22bo of the second projection lens 22b may be ea or less.

### Light Emitting Control

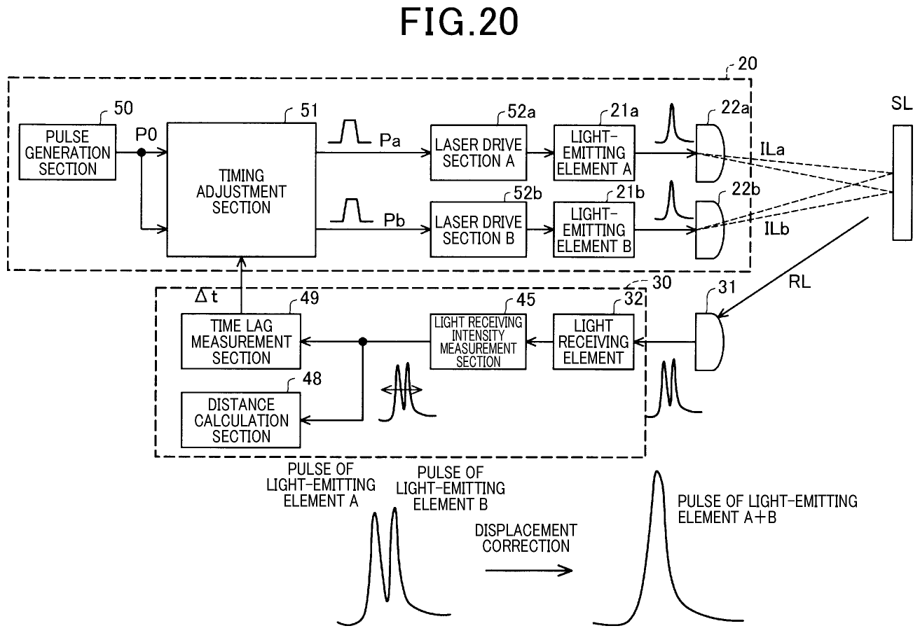

With reference to FIG. 20, control of the first light emitting element 21a and the second light emitting element 21b according to the above embodiments will be described. The light emitting control described with reference to FIG. 20 and later figures can be applied any of the first to seventh embodiments as described above. The light emitting part 20 includes a pulse generation section 50, a timing adjustment section 51, and laser drive sections 52a, 52b. The light receiving part 30 includes a light receiving element 32, a light receiving intensity measurement section 45, a distance calculation section 48, and a time lag measurement section 49.

The pulse generation section 50 generates a drive pulse P0. The drive pulse P0 is input to the timing adjustment section 51, which is an adjustment mechanism that adjusts emission timings of the two light emitting elements 21a, 21b. The timing adjustment section 51 adjusts a timing of the drive pulse PO to generate drive pulses Pa, Pb. An example of the configuration of the timing adjustment section 51 will be described later. A first laser drive section 52a receives the drive pulse Pa and drives the first light emitting element 21a to cause the first light emitting element 21a to emit the emitted beam ILa. A second laser drive section 52b receives the drive pulse Pb and drives the second light emitting element 21b to cause the second light emitting element 21b to emit the emitted beam ILb.

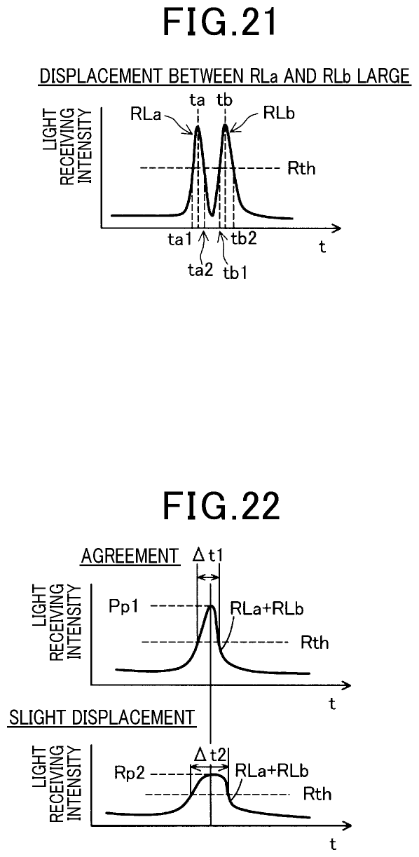

Reflected light RLa, RLb are received by the light receiving part 30. The light receiving intensity measurement section 45 measures light receiving intensity at the light receiving part 30. The light receiving intensity measurement section 45 uses, for example, a result of the histogram generation section 44 obtained when the reflected light RL is received from an object disposed at a predetermined distance to measure light receiving intensity. If emission timings of the first light emitting element 21a and the second light emitting element 21b are largely displaced from each other, an output signal of the light receiving intensity measurement section 45 has two peaks as illustrated in FIG. 21. If the emission timings of the first light emitting element 21a and the second light emitting element 21b agree with each other, the output signal has one peak as illustrated in an upper graph in FIG. 22. If the emission timings of the first light emitting element 21a and the second light emitting element 21b are slightly displaced from each other, the output signal has one peak, which is a broad peak, as illustrated in a lower graph in FIG. 22. The time lag measurement section 49 uses these waveforms to calculate a correction amount At for making the emission timings of the first light emitting element 21a and the second light emitting element 21b agree with each other, and transmits the calculated correction amount At to the timing adjustment section 51. For example, the timing adjustment section 51 may perform the timing adjustment when the optical distance measuring device 10 is subjected to a shipping inspection. Even after the timing adjustment section 51 is shipped and is installed in a vehicle, the timing adjustment may be intermittently performed when the vehicle is subjected to a periodic check or while the optical distance measuring device 10 is operating. Arranging reflection objects at appropriate distances, the timing adjustment can be performed more correctly. The timing adjustment section 51 may perform the timing adjustment while the vehicle is not traveling. When the four irradiated areas of laser beams are output by respective drive pulses, the timing adjustment section 51 may measure four displacements of the timings and correct the displacements individually.

FIG. 21 illustrates the reflected light RLa, RLb in a case in which a displacement between the emitted beams ILa and ILa is large. The graph illustrating the reflected light RLa, RLb corresponds to a curve obtained by smoothing the histogram illustrated in FIG. 5. When a displacement between the emitted beams ILa and ILa is large, received light waveforms of the reflected light RLa, RLb indicate a peak due to the emitted beam ILa and a peak due to the emitted beam ILb. In this case, the time lag measurement section 49 may directly obtain the two peak positions, that is, the time to at which the reflected light RLa of the emitted beam ILa peaks and the time tb at which the reflected light RLb of the emitted beam ILb peaks. The time lag measurement section 49 may determine the time ta1 at which the reflected light RLa of the emitted beam ILa exceeds a threshold value Rth and the time ta2 at which the reflected light RLa of the emitted beam ILa falls below the threshold value Rth, and determine the intermediate time (ta1+ta2)/2 as the time ta at which the reflected light RLa of the emitted beam ILa peaks. This is because although it may be difficult to determine whether the waveform has actually peaked at the time ta, the times ta1 and ta2 can be easily measured. Similarly, the time tb at which the reflected light RLb of the emitted beam ILb peaks may be determined. The times ta and tb can be easily determined.

FIG. 22 illustrates a case in which a displacement between the emitted beams ILa and ILb is small. When the timings of the emitted beams ILa and ILb agree with each other, the timings of the reflected light RLa, RLb also substantially agree with each other as in an ideal waveform. The reflected light RLa, RLb becomes one peak. The pulse width Δt1, which indicates a time period during which the peak exceeds the threshold value Rth, becomes the shortest. The peak value Rp1 becomes the highest. If the timings of the emitted beams ILa and ILb are slightly displaced from each other, the two emitted beams ILa and ILb overlap with each other, thereby forming a broad waveform. The pulse width Δt2, which indicates a time period during which the peak exceeds the threshold value Rth, becomes long, and the peak value Rp2 becomes low. As the amount of the displacement becomes larger, the pulse width Δt2 becomes larger and the peak value Lp2 becomes lower. Hence, the time lag measurement section 49 can determine the displacement between the emitted beams ILa and ILb by measuring the pulse width Δt2 and comparing the previously measured pulse width Δt1 of the ideal waveform. The time lag measurement section 49 may consider how much the peak value Rp2 is lowered with respect to the peak value Rp1.

The time lag measurement section 49 may repeat gradually changing the correction amount Δt and outputting the correction amount Δt, and measuring the time period Δt2 during which the two emitted beams ILa, ILb exceed the threshold value Rth when the correction amount Δt is output, to determine the correction amount Δt by which the time period Δt2 during which the two reflected light RLa, RLb exceed the threshold value Lth becomes the shortest.

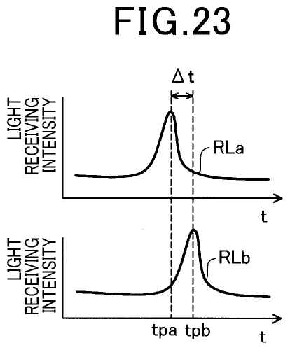

As shown in FIG. 23, the time lag measurement section 49 may acquire the time tpa at which the reflected light RLa peaks which is generated when only the first laser drive section 52a is driven to cause only the first light emitting element 21a to emit light and the time tpb at which the reflected light RLb peaks which is generated when only the second laser drive section 52b is driven to cause only the second light emitting element 21b to emit light, and determine the difference Δt between the time tpa and the time tpb as the correction amount. According to this method, since the reflected light RLa and the reflected light RLb do not overlap with each other, the times tpa and tpb can be acquired as in the method illustrated in FIG. 21.

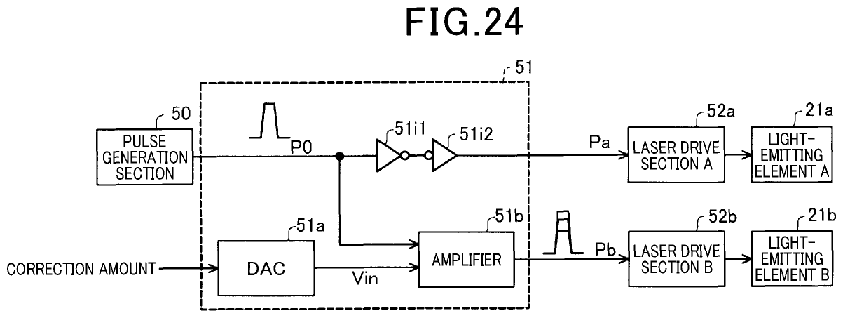

Next, an example of the configuration of the timing adjustment section 51 will be described. As illustrated in FIG. 24, the timing adjustment section 51 includes two inverters 51i1, 51i2, a digital-analog converter 51a (hereinafter, referred to as DAC 51a), and an amplifier 51b. The inverters 51i1, 51i2 generate the drive pulse Pb obtained by delaying the drive pulse P0. The DAC 51a converts the correction value At, which is a digital value calculated by the time lag measurement section 49, into analog voltage Vin. The amplifier 51b has a level shifter or a variable resistor and generates the drive pulse Pb, which is obtained by delaying the drive pulse P0, based on the analog voltage Vin.

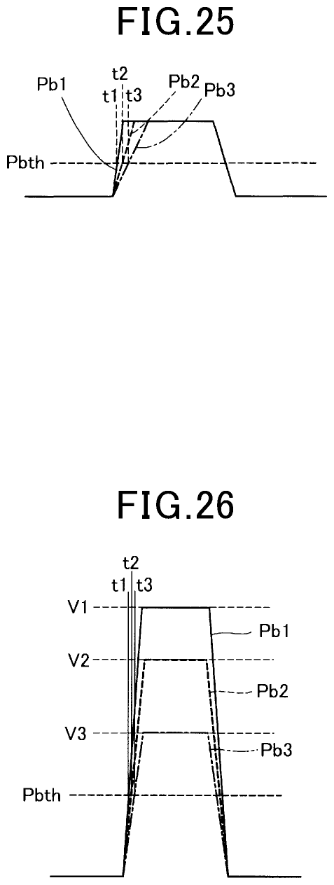

As shown in FIG. 25, the amplifier 51b adjusts a slew rate of a rise of a drive pulse Pb based on the input voltage Vin. For example, when Vin is high (Vin1), the amplifier 51b raises a drive pulse Pb1 with a short slew rate. In this case, the drive pulse Pb1 exceeds an input threshold value Pbth of the second laser drive section 52b at time t1. If the amplitude of the drive pulse Pb1 exceeds the input threshold value Pbth, electrical power is supplied to the light emitting element 21b, whereby the light emitting element 21b emits light. When Vin is Vin2 lower than Vin1, the amplifier 51b raises the drive pulse Pb with a slew rate longer than that of the drive pulse Pb1 as in Pb2. In this case, the drive pulse Pb exceeds the input threshold value Pbth of the second laser drive section 52b at time t2. Time t2 is later than time t1. Similarly, when Vin is Vin3 lower than Vin2, the drive pulse Pb exceeds the input threshold value Pbth of the second laser drive section 52b at time t3 later than t2, electrical power is supplied to the light emitting element 21b, whereby the light emitting element 21b emits light. In this manner, the amplifier 51b adjusts a slew rate of a rise of the drive pulse Pb based on the input voltage Vin. For example, if the amounts of delay of the two inverters 51i1, 51i2 are set so that the first light emitting element 21a and the second light emitting element 21b emit light at approximately the same time when Vin is Vin2, the emission timing of the second light emitting element 21b can be earlier with respect to the emission timing of the first light emitting element 21a when Vin is Vin1, and the emission timing of the second light emitting element 21b can be later with respect to the emission timing of the first light emitting element 21a when Vin is Vin3.

In the example illustrated in FIG. 25, the amplifier 51b adjusts a slew rate of the drive pulse Pb. In contrast, in the example illustrated in FIG. 26, the amplifier 51b adjusts a peak voltage of the drive pulse Pb based on the input voltage Vin. For example, when Vin is high (Vin1), the amplifier 51b sets a peak voltage of the drive pulse Pb1 to V1. In this case, the drive pulse Pb exceeds the input threshold value Pbth of the second laser drive section 52b at time t1. Similarly, when Vin is Vin2 lower than Vin1, the drive pulse Pb2 exceeds the input threshold value Pbth at time t2 later than t1. When Vin is Vin3 lower than Vin2, the drive pulse Pb3 exceeds the input threshold value Pbth at time t3 later than t2. In this manner, the amplifier 51b can adjust the emission timing of the light emitting element 21b by adjusting peak voltage of the drive pulse Pb based on the input voltage Vin.

Although the timing adjustment section 51 adjusts the timing of the drive pulse Pb, the timing adjustment section 51 may adjust the timing of the drive pulse Pa, and both the timings of the drive pulses Pa, Pb.

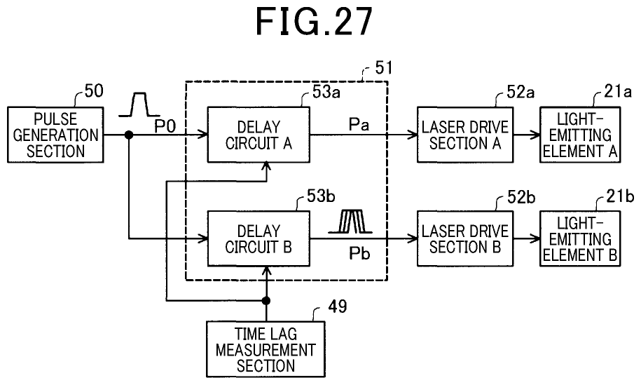

In the examples illustrated in FIG. 25 and FIG. 26, the waveform (slew rate or peak voltage) of the drive pulse Pb is changed. In contrast, in the example illustrated in FIG. 27, the timing adjustment section 51 includes a delay circuit. The timing adjustment section 51 includes a first delay circuit 53a that delays the drive pulse PO to generate the drive pulse Pa and a second delay circuit 53b that delays the drive pulse P0 to generate the drive pulse Pb.

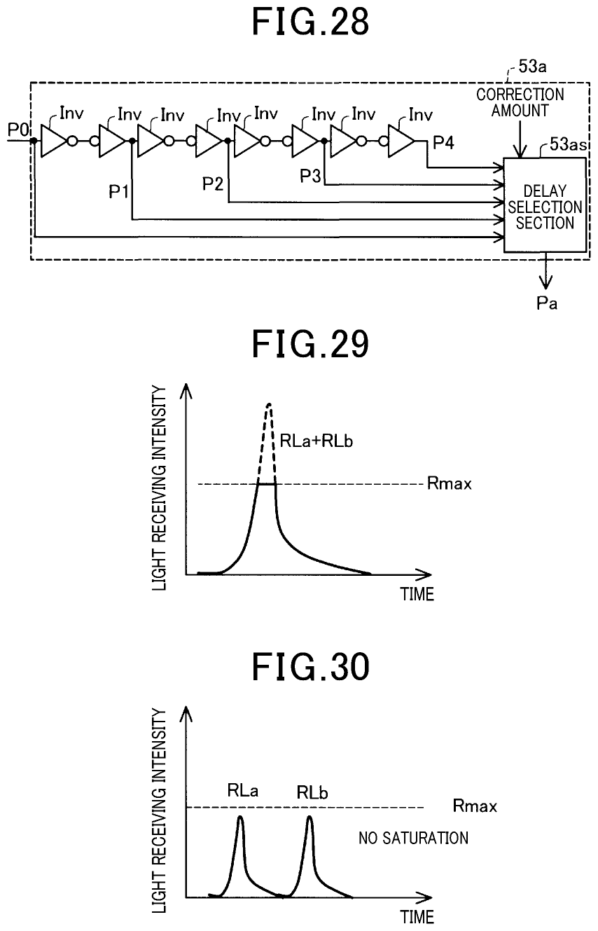

As shown in FIG. 28, the first delay circuit 53a includes a plurality of inverters INV connected in series and a delay selection section 53as. The delay selection section 53as receives the drive pulse P0 and outputs from the even-numbered inverters INV, and selects one of the drive pulse P0 and the outputs from the even-numbered inverters INV according to a correction amount to output it as the drive pulse Pa. In this manner, the first delay circuit 53a outputs the drive pulse Pa obtained by delaying the drive pulse P0. If the delay selection section 53as selects the drive pulse P0, the drive pulse Pa agrees with the drive pulse P0, and the first delay circuit 53a outputs the drive pulse Pa that is not delayed substantially. The second delay circuit 53b is similar to the first delay circuit 53a, and delays the drive pulse P0 to generate the drive pulse Pb. One of the first delay circuit 53a and the second delay circuit 53b, for example, the first delay circuit 53a may not include the delay selection section 53as but include only multiple, for example, two inverters INV. In this case, causing the delay selection section 53as to select the drive pulse P0 can delay the drive pulse Pa with respect to the drive pulse Pb. Causing the delay selection section 53as to select an output P1 from the second inverter can make the drive pulse Pa and the drive pulse Pb to be at approximately the same timing. Causing the delay selection section 53as to select an output P2 from the fourth inverter can delay the drive pulse Pb with respect to the drive pulse Pa.

According to the above form, the timing adjustment section 51 can make emission timings of the light emitting elements 21a, 21b agree with each other even when any of the emission timings of the light emitting elements 21a, 21b is earlier.

FIG. 29 illustrates a case where the emitted beams ILa, ILb are emitted to an object having a high reflectivity, and the light receiving part 30 receives the reflected light RL thereof. In this case, the light receiving intensity exceeds the maximum range Rmax of the light receiving part 30. In this case, part where the light receiving intensity exceeds the maximum range Rmax is broad. Hence, the light receiving intensity measurement section 45 cannot exactly determine peaks of the reflected light RLa, RLb. It may be difficult for the distance calculation section 48 to exactly measure a distance to the object having a high reflectivity. In this case, the measurement section 40 may use light receiving intensity of the reflected light RLa, RLb in the light receiving part 30 to adjust light emitting timings so as to cause the timing adjustment section 51 to intentionally differentiate the light emitting timings of the first light emitting element 21a and the second light emitting element 21b from each other. As a result, as illustrated in FIG. 30, the light receiving intensity of the reflected light RLa of the emitted beam ILa does not exceed the maximum range Rmax of the light receiving part 30. The light receiving intensity of the reflected light RLb of the emitted beam ILb does not exceed the maximum range Rmax of the light receiving part 30. Accordingly, the light receiving intensity measurement section 45 can correctly determine the peaks of the reflected light RLa, RLb to measure a distance to the object having a high reflectivity. Since the amounts of adjustments of the light emitting timing of the emitted beam ILa and the light emitting timing of the emitted beam ILb performed by the timing adjustment section 51 are previously known, the distance calculation section 48 can easily perform the correction.

When the timing adjustment section 51 adjust the light emitting timing of the emitted beam ILa and the light emitting timing of the emitted beam ILb, the light emitting timing of the emitted beam ILa and the light emitting timing of the emitted beam ILb may be the same or different from each other as illustrated in FIG. 29 and FIG. 30.

The present disclosure is not limited to the above-described embodiments and can be implemented with various configurations within a scope not deviating from the gist of the present disclosure. For example, technical featured in the above-described embodiment can be replaced or combined as appropriate to solve part or all of the above-described problems to be solved or to achieve part or all of the above-described effects. Further, the technical features, which are not described as essential features in the present specification, can be deleted as appropriate.

According to an aspect of the present disclosure, an optical distance measuring device (10) using light is provided. The optical distance measuring device includes: a light emitting part (20) in which a first light emitting element (21a) and a second light emitting element (21b) that have a light emitting region, in which a length in a first direction (z direction) is longer than a length in a second direction (y direction) intersecting the first direction, are separated from each other in the second direction by a predetermined distance; two projection lenses (22a, 22b) that are respectively provided to correspond to the first light emitting element and the second light emitting element, and are separated from each other in the second direction and arranged at positions overlapping each other in the first direction; a scanner (26) that scans a measurement range with emitted beams emitted from the light emitting part and have passed through the two projection lenses; a light receiving part (30) that receives reflected light of the emitted beams emitted from the light emitting part; and a measurement section (40) that measures a distance to an object according to a time period from light emission by the light emitting part to light reception by the light receiving part.

According to the aspect, an angular width of the emitted beam can be enlarged while maintaining intensity of light at a target of the emission of the emitted beam.

What is claimed is:

1. An optical distance measuring device using light, the device comprising:
a light emitting part in which a first light emitting element and a second light emitting element that have a light emitting region, in which a length in a first direction is longer than a length in a second direction intersecting the first direction, are separated from each other in the second direction by a predetermined distance;
two projection lenses that are respectively provided to correspond to the first light emitting element and the second light emitting element, and are separated from each other in the second direction and arranged at positions overlapping each other in the first direction;
a scanner that scans a measurement region with emitted beams emitted from the light emitting part and have passed through the two projection lenses;
a light receiving part that receives reflected light of the emitted beams emitted from the light emitting part; and
a measurement section that measures a distance to an object according to a time period from light emission by the light emitting part to light reception by the light receiving part.

2. The optical distance measuring device according to claim 1, wherein
each of the first light emitting element and the second light emitting element has a plurality of light emitting regions arranged in the first direction in a state in which non-light emitting regions are provided between the light emitting regions;
a size of the non-light emitting region in the first direction is smaller than a size of the light emitting region in the first direction; and
the first light emitting element and the second light emitting element are shifted from each other in the first direction so that the light emitting region of the first light emitting element is locate at a position at which the light emitting region of the first light emitting element overlaps with the non-light emitting region of the second light emitting element in the first direction.

3. The optical distance measuring device according to claim 2, wherein
optical axes of the two projection lenses are parallel to each other,
the first light emitting element is shifted from the optical axis of the corresponding projection lens in the first direction, and the second light emitting element is shifted from the optical axis of the corresponding projection lens in the direction opposite to the first direction.

4. The optical distance measuring device according to claim 2, wherein
optical axes of the two projection lenses are parallel to each other,
the first light emitting element is located on the optical axis of the corresponding projection lens, and the second light emitting element is located on the optical axis of the corresponding projection lens, and
the optical axes of the two projection lenses are shifted from each other in the first direction.

5. The optical distance measuring device according to claim 2, wherein
the first light emitting element is located on the optical axis of the corresponding projection lens, and the second light emitting element is located on the optical axis of the corresponding projection lens, and
the two optical axes of the two projection lenses are respectively inclined in the first direction and in a direction opposite to the first direction.

6. The optical distance measuring device according to claim 1, wherein
the first light emitting element and the second light emitting element are arranged so that a first area subjected to emission to the measurement region by the first light emitting element and a second area subjected to emission to the measurement region by the second light emitting element contact each other in the first direction.

7. The optical distance measuring device according to claim 6, wherein
the first light emitting element is located on the optical axis of the corresponding projection lens, and the second light emitting element is located on the optical axis of the corresponding projection lens, and
the two optical axes of the two projection lenses are respectively inclined in the first direction and in a direction opposite to the first direction.

8. The optical distance measuring device according to claim 6, wherein
optical axes of the two projection lenses are parallel to each other, and
the first light emitting element is shifted from the optical axis of the corresponding projection lens in the first direction, and the second light emitting element is shifted from the optical axis of the corresponding projection lens in the first direction.

9. The optical distance measuring device according to claim 1, further comprising a cylindrical lens that is provided at a subsequent stage of the two projection lenses and enlarges an angular width in the first direction.

10. The optical distance measuring device according to claim 1, wherein
the light receiving part includes light receiving elements arranged in a two-dimensional array, and
signal processing for each row provided in the second direction is performed.

11. The optical distance measuring device according to claim 1, further comprising:
a first substrate on which first light emitting element is disposed; and
a second substrate on which second light emitting element is disposed, wherein
a surface of the first substrate on which the first light emitting element is disposed and a surface of the second substrate on which the second light emitting element is disposed face to each other.

12. The optical distance measuring device according to claim 11, further comprising light guiding paths that are provided at a subsequent stage of the two projection lenses and narrow a distance in the second direction between a first emitted beam emitted from the first light emitting element and a second emitted beam emitted from the second light emitting element.

13. The optical distance measuring device according to claim 1, wherein
a distance between central axes of the two projection lenses is an effective diameter of the projection lenses, and
the optical distance measuring device further comprises a light shielding wall.

14. The optical distance measuring device according to claim 1, further comprising:
a pulse generation section that generates a drive pulse;
a laser drive section that uses the drive pulse to cause the first light emitting element and the second light emitting element to emit light; and
an adjustment mechanism that adjusts emission timings of the first light emitting element and the second light emitting element.

15. The optical distance measuring device according to claim 14, wherein
the adjustment mechanism is an amplifier that is disposed between the pulse generation section and the laser drive section and adjusts at least one of a slew rate and a voltage of the drive pulse.

16. The optical distance measuring device according to claim 14, wherein
the adjustment mechanism is a delay circuit disposed between the pulse generation section and the laser drive section.

17. The optical distance measuring device according to claim 14, wherein
a time lag is detected by using a received light waveform of reflected light of the first light emitting element and a received light waveform of reflected light of the second light emitting element in the light receiving part.

18. The optical distance measuring device according to claim 17, wherein
a displacement between emission timings of the first light emitting element and the second light emitting element is detected by using at least one of a pulse width and a peak position of the received light waveform in the light receiving part.

19. The optical distance measuring device according to claim 14, wherein
the emission timings of the first light emitting element and the second light emitting element are adjusted by using light receiving intensity of the reflected light in the light receiving part.
